(19) United States
(12) Patent Application Publication
(10) Pub. No.: US 2007/0043900 A1
(43) Pub. Date: Feb. 22, 2007

(54) Flash memory management method and flash memory system

(75) Inventor: Hee-chul Yun, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/362,720

(22) Filed: Feb. 28, 2006

(30) Foreign Application Priority Data
Aug. 20, 2005 (KR) 2005-76546

(51) Int. Cl. G06F 12/00

(52) U.S. Cl. 711/103

(57) ABSTRACT

A flash memory management method for effectively deleting a file and a flash memory system, the flash memory system including: a flash memory; and an interface determining whether a sensed sector write operation instructs a file system to delete a file by examining metadata of the file system and deleting data in the flash memory corresponding to the file if the sensed sector write operation instructs deletion of the file. Accordingly, an interface layer between the flash memory and the file system can prevent unnecessary data from being copied in a future garbage collection process by recognizing a delete operation of the file system and quickly performing a future rewrite operation since actual data blocks are erased in file deletion.

### CROSS-REFERENCE TO RELATED APPLICATION

This application claims the benefit of Korean Patent Application No. 2005-76546, filed on Aug. 20, 2005 in the Korean Intellectual Property Office, the disclosure of which is incorporated herein in its entirety by reference.

### BACKGROUND OF THE INVENTION

1. Field of the Invention

An aspect of the present invention relates to a flash memory, and more particularly, to a flash memory management method and a flash memory system for effectively deleting a file.

2. Description of the Related Art

A flash memory is a kind of Electrically Erasable and Programmable Read Only Memory (EEPROM) and is largely divided into a NOR type flash memory supporting byte input/output (I/O) and a NAND type flash memory supporting only page I/O. The NOR type flash memory is usually used as a memory for codes because of a fast read speed and a slow write speed, and the NAND type flash memory is mainly used as a bulk data storage unit because of a relatively fast write speed and a low cost per unit space.

However, unlike a disk drive, for the flash memory, an erase operation must be performed in advance to perform a rewrite operation, the flash erase operation is performed in a much greater block unit than a write operation, and the execution time of the flash erase operation is long. When the flash memory is used as an auxiliary memory unit, these characteristics impede the use of a file system of a hard disk drive in the flash memory. To solve this, a flash translation layer (FTL), which is a middleware between a disk file system and a flash memory, was suggested in Korean Patent No. 389867 and U.S. Pat. No. 5,404,485. The FTL is an interface layer for freely reading and writing from and in a flash memory as a hard disk drive.

FIG. 1 is a general hardware configuration of a device using a flash memory. A central processing unit (CPU) 101 executes an application program stored in a Random Access Memory (RAM) 104 and issues a series of commands for a flash controller 102 to read or write data from or in a flash memory 103, and the flash controller 102 directly controls the flash memory 103.

FIG. 2 is a software stack of a flash memory system using an FTL, which includes an application 201, a file system 202, an FTL 203, and a flash memory 204. The file system 202, which has received a read/write request from the application 201, outputs a sector address, which is a read/write object, to the FTL 203, and the FTL 203 translates the sector address to a physical address (a block number and a page number) and outputs the physical address to the flash memory 204.

As illustrated in FIG. 3, an FTL translates a sector address or number, which is a logical address of a virtual disk, to a block number and a page number, which is a physical address of a flash memory. In addition, as illustrated in FIG. 4, an FTL emulates a read/program/erase operation performed in a flash device similar to a read/write operation performed in a disk device.

An address translation of an FTL can be achieved using a virtual mapping table. A mapping method is largely divided into a page mapping method and a block mapping method. The page mapping method performs the address translation in a page basis (below 2 KB), and the block mapping method performs the address translation in a block basis (below 128 KB).

FIG. 5 illustrates an address translation mechanism according to the block mapping method. For example, a logical address ‘sector 6’ is divided into a logical block number and a logical offset, respectively mapped to a physical block number and a physical offset, and translated to ‘page2 of block0’ of a flash memory.

Since an FTL emulates a flash device, to show it as a randomly readable/writable disk using the block mapping method, a disk-based file system, such as a file allocation table (FAT) file system, can be located above the FTL. FIG. 6 illustrates a structure of an FAT table of an FAT file system, wherein a file is represented as a linked list of addresses in which real data is stored, and this file information is managed as a table. Referring to FIG. 6, FAT entries 0, 1, and 5 indicate free areas in which data is not recorded, a file A is stored in an area indicated by FAT entries 4, 7, and 2, and a file B is stored in an area indicated by FAT entries 6 and 3. The FAT table is stored in a beginning portion of a disk separately from an area in which contents of files are stored, and when a file is deleted, only the FAT table is updated, and contents in real data blocks corresponding to the deleted file indicated by the FAT table remain.

In other words, when an FAT file system is used as an upper layer of an FTL, when performing a file deletion, a relevant file is not really deleted but only an FAT table and a directory entry corresponding to the file are updated, and therefore the FTL, which is a lower layer, does not know that sectors of the deleted file are invalid. Likewise, in most other file systems, only metadata of a deleted file is updated, and data of sectors in which the file has been actually recorded remains in a flash memory.

The mechanism described above is effective in an infinitely overwritable device, such as a hard disk but ineffective in a flash device. An FTL provides abstraction to allow a flash memory to be logically rewritten. However, in reality, when a rewrite occurs, data must be recorded in a free space of the flash memory, and if free space does not exist, a garbage collection or merge operation for generating new free blocks must be performed, and therefore processing speed is slowed.

FIG. 7 illustrates a garbage collection process of an FTL, which was suggested in Korean Patent No. 389867. Here, data of one logical block can be recorded in a maximum of two blocks (a data block and a log block), and when data cannot be rewritten in the two blocks any more due to continuous rewrite operations, a merge operation for merging the two blocks into one is performed, and then a rewrite operation proceeds. That is, in FIG. 7, the data block and the log block become erasable blocks after merged to a free block. According to this mechanism, the time for performing a block copy operation and two flash erase operations is required for a sector write operation. In addition, even if a file is deleted from a file system, only metadata, such as an FAT table, is updated, and an actual data block remains as is, and accordingly, the FTL recognizes all data of the deleted file as a valid page and copies them too. If FTL can know whether a certain sector has data of an actually deleted file, such an overhead can be removed.

### SUMMARY OF THE INVENTION

According to an aspect of the present invention, there is provided a flash memory management method for reducing a load due to an unnecessary copying of data in garbage collection, thus guaranteeing the same write speed of a first write when rewriting a file of a flash memory after deletion of the file by an interface module, such as a flash translation layer (FTL), recognizing the deletion of the file from a file system located at an upper layer and then invalidating a flash memory area corresponding to the deleted file or erasing data in the flash memory area and a flash memory system using the same.

According to another aspect of the present invention, there is provided a flash memory management method for performing an effective write operation by sensing that a file system performs a write operation of metadata and determining whether the write operation is to delete a file and a flash memory system using the same.

According to an aspect of the present invention, there is provided a flash memory management method using a file system, the method including sensing a sector write operation; determining whether the sensed sector write operation relates to an area in which metadata of the file system is stored; and managing a flash memory according to the determination.

According to another aspect of the present invention, the managing of the flash memory includes: if the sector write operation relates to the area in which metadata of the file system is stored, determining a target of the sector write operation by comparing information on the metadata area with information on a write buffer of the sector write operation.

According to another aspect of the present invention, the managing of the flash memory further includes: if the target of the sector write operation is a deletion of a file, deleting data of the flash memory corresponding to the file.

According to another aspect of the present invention, the deleting of the file includes: invalidating pages of the flash memory in which the data is stored by indicating that the pages are in a deleted area.

According to another aspect of the present invention, the deleting of the file further includes: checking a state of blocks to which the invalidated pages belong; and erasing blocks whose all pages are invalidated among the blocks by performing a flash erase operation.

According to another aspect of the present invention, the managing of the flash memory further includes: recording the information on the write buffer in the metadata area.

According to another aspect of the present invention, there is provided a flash memory management method using a file system, the method includes: reading information on a boot sector when the file system is mounted; obtaining information of the file system by examining the information on the boot sector; and managing a flash memory according to the information of the file system.

According to another aspect of the present invention, the managing of the flash memory includes: obtaining a type of the file system and a position of an area in which metadata is stored using the information of the file system.

According to another aspect of the present invention, there is provided a flash memory system using a file system, the flash memory system includes: a flash memory; and an interface determining whether a sensed sector write operation instructs the file system to delete a file by examining metadata of the file system and deleting data in the flash memory corresponding to the file if the sector write operation instructs the file deletion.

According to another aspect of the present invention, the flash memory system further includes: a nonvolatile random access memory (RAM) in which the metadata is recorded.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a general hardware configuration of a device using a flash memory;

FIG. 2 is a software configuration of a flash memory system using a flash translation layer (FTL);

FIG. 3 illustrates an address translation mechanism of an FTL;

FIG. 4 illustrates operations of an FTL;

FIG. 5 illustrates a block mapping method of an address translation mechanism of an FTL;

FIG. 6 illustrates a structure of an FAT table;

FIG. 7 illustrates a garbage collection process of an FTL;

FIG. 8 is a flowchart of a flash management method according to an embodiment of the present invention;

FIGS. 9A and 9B are diagrams illustrating comparison of an FAT table before file deletion to the FAT table after the file deletion;

FIG. 10 is a block diagram of a flash memory system according to an embodiment of the present invention; and

FIG. 11 is a graph illustrating a result of performance comparison between a flash management method according to an embodiment of the present invention and flash management methods according to the related art.

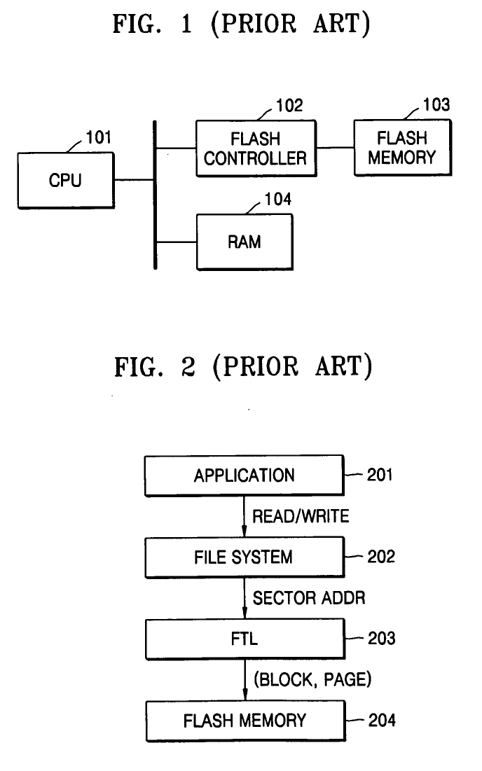

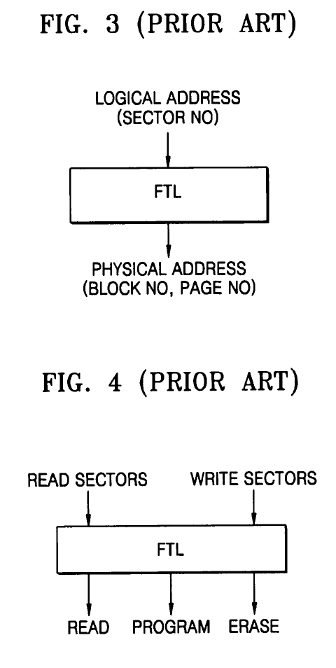

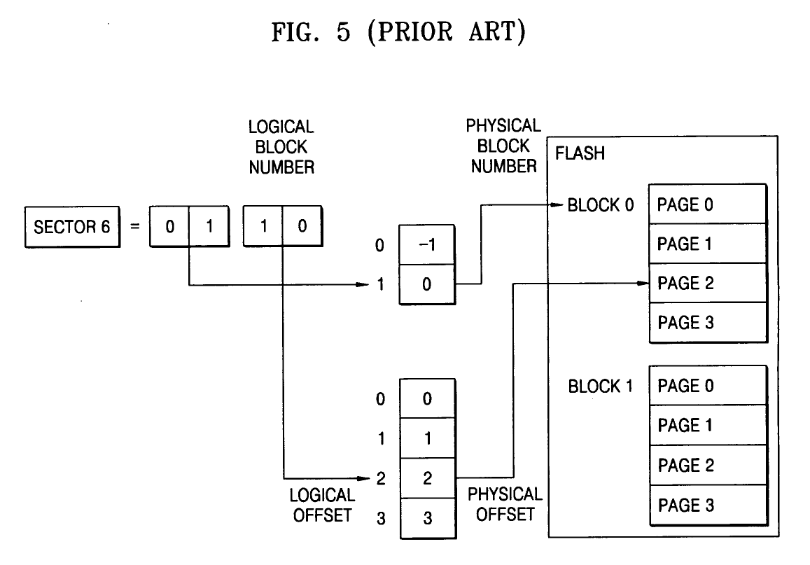

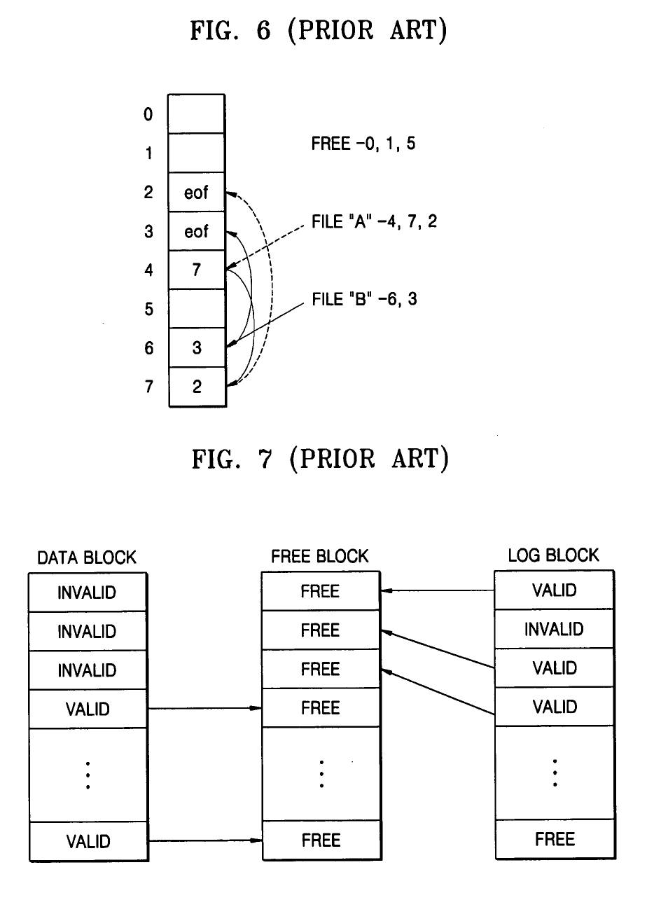

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

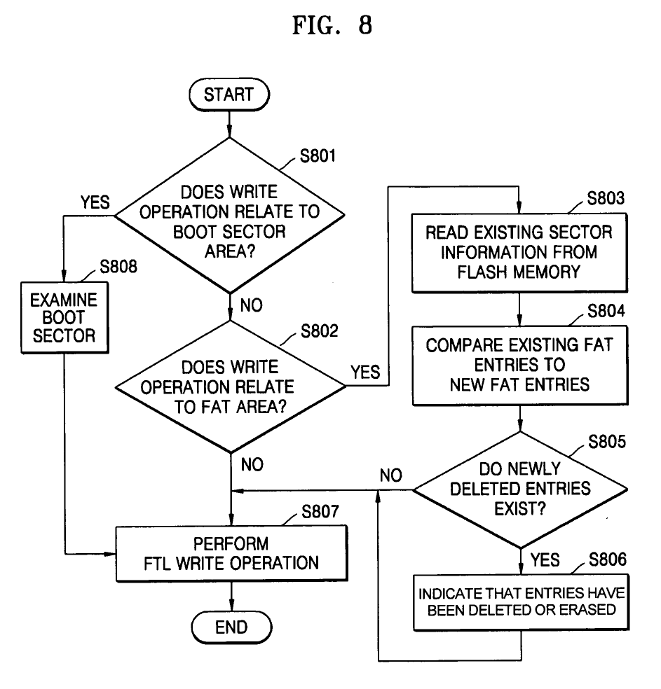

FIG. 8 is a flowchart illustrating a mechanism for processing a sector write operation in a flash management method according to an embodiment of the present invention. A method of obtaining basic information of a file system in an interface, such as an FTL, is by examining a boot sector. The boot sector can be read when the file system is mounted or generated, and the basic information of the file system, such as which type of file system and where metadata of the file system is recorded, can be obtained by examining information on the boot sector and used to manage a flash memory. Although an aspect of the present embodiment is described based on an FAT file system, the present invention is not limited to a specific file system.

When an FTL senses a sector write operation, it is determined whether the sector write operation relates to a boot sector in operation S801. If the sector write operation relates to the boot sector, information on the boot sector is examined in operation S808, and an FTL write operation is performed based on the examination result in operation S807.

If the sector write operation does not relate to the boot sector, it is determined whether the sector write operation relates to an area in which metadata of a file system is stored in operation S802. As described above, since a location of the metadata of the file system can be obtained by using information on the file system obtained when the file system is mounted, it can be known whether the sector write operation relates to the metadata. In the present embodiment, it is determined whether the sector write operation relates to an area in which an FAT table is stored.

If the sector write operation does not relate to the FAT area, a general FTL write operation corresponding to the sector write operation is performed in operation S807. That is, the FTL converts a logical address to which the sector write operation is applied to a physical address and records contents of a write buffer in the physical address of the flash memory.

When the sensed sector write operation relates to the area in which the metadata is stored, a target of the sector write operation is determined by comparing existing information recorded in the metadata area with information stored in the write buffer for the sector write operation using the method described below.

When the sector write operation relates to the FAT area, metadata information, i.e., FAT entries, of a sector corresponding to a destination of the sector write operation is read from the flash memory in operation S803, the read FAT entries are compared to new FAT entries, which are contents of the write buffer, in operation S804, and it is examined whether newly deleted FAT entries exist in operation S805. Since a write unit of the flash memory is a sector, the comparison must be performed for each sector. That is, which FAT entries have been updated are examined by comparing one by one all FAT entries included in the sector corresponding to the destination of the sector write operation with all FAT entries included in a sector stored in the write buffer. When an i^{th} FAT entry of the FAT table is compared, if an existing i^{th} FAT entry is not 0 while data to be newly written is 0, i.e., if old(i)!=0 and new(i)=0, the i^{th} FAT entry indicates a flash memory area deleted by a file deletion operation of the file system, and if such FAT entries are discovered, the sensed sector write operation instructs file deletion.

In the comparison process, since a logical block address indicated by a deleted FAT entry can be translated to a block number and a page number of the flash memory using a mapping function of the FTL, a physical address corresponding to a file to be deleted can be obtained. Data of the flash memory corresponding to the file to be deleted is deleted using the physical address, and the data deletion from the flash memory is performed using invalidating and erase operations. In other words, pages having the physical address are invalidated by marking a deleted area, and a state of blocks to which these pages belong is examined. If a block of which all pages are invalidated exists, a new block is generated by erasing the block through the flash erase operation in operation S806.

Finally, according to the initially sensed sector write operation, the information stored in the write buffer is recorded in the sector in the FAT area in operation S807.

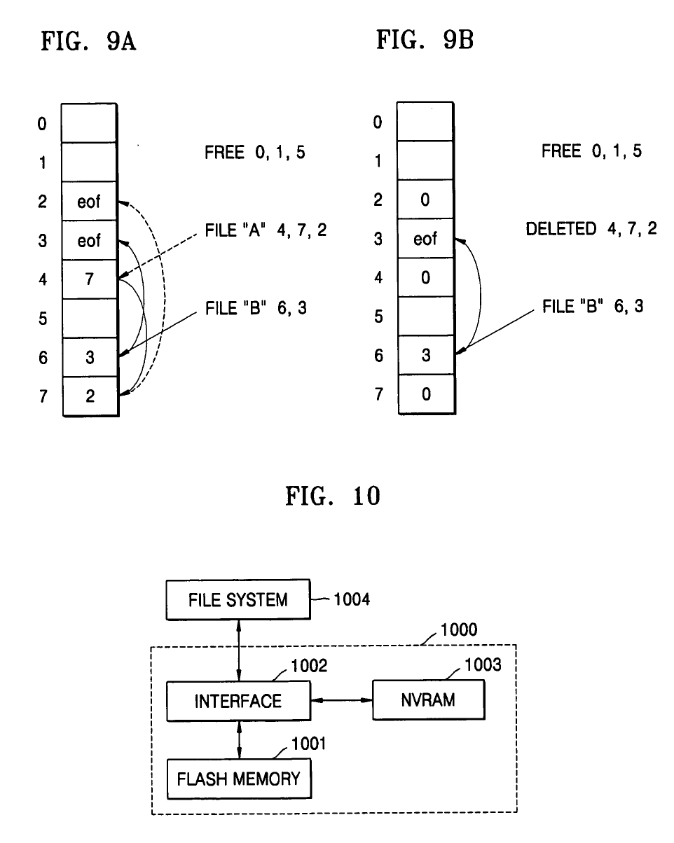

FIGS. 9A and 9B are diagrams illustrating a comparison of an FAT table before and after file deletion. Referring to FIGS. 9A and 9B, files A and B exist in the FAT table at first, and then the file A is deleted. As illustrated in FIG. 9A, if data to be newly written in FAT entries 4, 7, and 2 of the file A are all ‘0s’ while values of the FAT entries 4, 7, and 2 are ‘7’, ‘2’, and ‘eof’, it can be anticipated that a target of a sensed sector write operation is deletion of the file A. In this case, areas of a flash memory corresponding to the FAT entries 4, 7, and 2 are invalidated or erased according to the algorithm illustrated in FIG. 8, and the values of the FAT entries 4, 7, and 2 are changed to ‘0’ as illustrated in FIG. 9B.

FIG. 10 is a block diagram of a flash memory system 1000 according to an embodiment of the present invention, which includes a flash memory 1001 and an interface 1002 and links to a file system 1004. In addition, performance can be more improved by adding a nonvolatile RAM (NVRAM) 1003 to the flash memory system 1000.

The interface 1002 is a device performing the flash memory management method described above and determines whether a sensed sector write operation is to delete a file by reading and examining contents of current metadata and comparing the contents of the current metadata with contents of a write buffer of the sector write operation. If the sector write operation is to delete a file, the interface 1002 actually deletes data in the flash memory 1001 corresponding to the file. If the metadata of the file system is stored in the NVRAM 1003, when a target of the sector write operation is determined, the comparison of the data can be directly performed in the NVRAM 1003 instead of reading the metadata from the flash memory 1001 and comparing with data to be newly written, therefore reducing operation time.

As described above, according to embodiments of the present invention, an FTL can recognize a delete operation of an upper layer, prevent unnecessary data from being copied in a future garbage collection process, and quickly perform a future rewrite operation since actual data blocks are erased in file deletion.

These characteristics are very useful for products, such as a camcorder, needing to store data in real-time. That is, while a write speed may not satisfy real-time requirements when recording is repeatedly performed using a camcorder according to the related art, performance similar to an initial write operation can be obtained in a rewrite operation according to an aspect of the present invention, and therefore real-time performance can be dramatically increased.

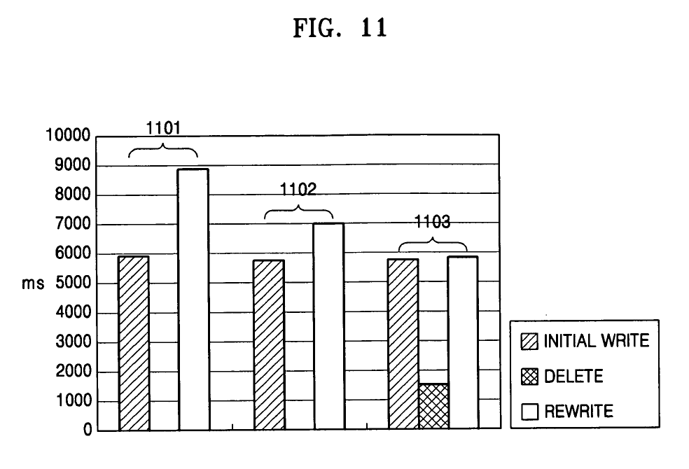

FIG. 11 is a graph illustrating test results by which this characteristic can be recognized.

From the left, the graph shows test results of a case 1101 where a flash file system according to U.S. Pat. No. 5,404,485 is implemented, a case 1102 where a flash memory management method according to Korean Patent No. 389867 is implemented, and a case 1103 where a flash memory management method according to an aspect of the present invention is implemented. Conditions are all the same, and the results are respectively obtained by measuring the times taken for (1) a case where data is initially fully written (≡), (2) a case where the data recorded in (1) is deleted (▪), and (3) a case where data is fully recorded again (□). As illustrated in FIG. 11, according to an aspect of the present invention, a rewrite operation can maintain almost the same write speed of an initial write operation.

In addition, since comparison of new and old data can be directly performed in an NVRAM by storing an FAT table in the NVRAM, the performance can be further increased.

While this invention has been particularly shown and described with reference to embodiments thereof, it will be understood by those skilled in the art that various changes in form and details may be made therein without departing from the spirit and scope of the invention as defined by the appended claims. The above-described embodiments should be considered in a descriptive sense only and are not for purposes of limitation. Therefore, the scope of the invention is defined not by the detailed description of the invention but by the appended claims, and all differences within the scope will be construed as being included in the present invention.

What is claimed is:

1. A flash memory management method using a file system, the method comprising:
sensing a sector write operation;
determining whether the sector write operation relates to an area in which metadata of the file system is stored; and
managing a flash memory according to the determination.

2. The method of claim 1, wherein the managing of the flash memory comprises:
if the sector write operation relates to the area in which the metadata of the file system is stored, determining a target of the sector write operation by comparing information on the metadata area with information on a write buffer of the sector write operation.

3. The method of claim 2, wherein the managing of the flash memory further comprises:
if the target of the sector write operation is deletion of a file, deleting data of the flash memory corresponding to the file.

4. The method of claim 3, wherein the deleting of the file comprises:
invalidating pages of the flash memory in which the data is stored by indicating that the pages are in a deleted area.

5. The method of claim 4, wherein the deleting of the file further comprises:
checking a state of blocks to which the invalidated pages belong; and
erasing the blocks whose all pages are invalidated among the blocks by performing a flash erase operation.

6. The method of claim 5, wherein the managing of the flash memory further comprises:
recording the information on the write buffer in the metadata area.

7. A flash memory management method using a file system, the method comprising:
reading information on a boot sector when the file system is mounted;
obtaining information on the file system by examining the information on the boot sector; and
managing a flash memory according to the information on the file system.

8. The method of claim 7, wherein the managing of the flash memory comprises:
obtaining a type of the file system and a position of an area in which metadata is stored using the information on the file system.

9. The method of claim 8, wherein the managing of the flash memory further comprises:
sensing a sector write operation;
determining whether the sector write operation relates to an area in which the metadata of the file system is stored; and
if the sector write operation relates to the area in which the metadata of the file system is stored, determining a target of the sector write operation by comparing information on the metadata area with information on a write buffer of the sector write operation.

10. The method of claim 9, wherein the managing further comprises:
if the target of the sector write operation is deletion of a file, deleting data stored in the flash memory corresponding to the file.

11. The method of claim 10, wherein the deleting of the file comprises:
invalidating pages of the flash memory in which the data is stored by indicating that the pages are in a deleted area.

12. The method of claim 11, wherein the deleting of the file further comprises:
checking a state of blocks to which the invalidated pages belong; and
erasing the blocks whose all pages are invalidated among the blocks by performing a flash erase operation.

13. A flash memory system using a file system, the flash memory system comprising:
a flash memory; and
an interface determining whether a sensed sector write operation instructs the file system to delete a file by examining metadata of the file system and deleting data in the flash memory corresponding to the file if the sensed sector write operation instructs the file deletion.

14. The flash memory system of claim 13, wherein the interface determines that a target of the sensed sector write operation instructs the deletion of the file by comparing information on a metadata area with information on a write buffer of the sector write operation if the sensed sector write operation relates to the metadata area in which the metadata of the file system is stored.

15. The flash memory system of claim 14, wherein the interface deletes the data by invalidating pages of the flash memory in which the data is stored by indicating that the pages are in a deleted area.

16. The flash memory system of claim 15, wherein the interface deletes the data by checking a state of blocks to which the invalidated pages belong and erasing the blocks whose all pages are invalidated among the blocks by performing a flash erase operation.

17. The flash memory system of claim 14, further comprising:
a nonvolatile random access memory (NVRAM) in which the metadata is recorded.

18. The flash memory system of claim 13, wherein the file system is a file allocation system (FAT) file.

19. The flash memory system of claim 17, wherein when a target of the sensed sector write operation is determined, directly comparing the contents of the current metadata with the contents of the write buffer of the sector write operation in the NVRAM.

20. The flash memory system of claim 14, wherein if the contents of a current i^{th} metadata is not 0 while data to be newly written is 0, the current i^{th}metadata indicates a flash memory area deleted by a file deletion operation of the file system, and if such metadata is discovered, the sensed sector write operation instructs file deletion.
